(19) United States
(12) Patent Application Publication
(10) Pub. No.: US 2015/0177838 A1
(43) Pub. Date: Jun. 25, 2015

(54) METHOD AND SYSTEM FOR PROVIDING HAPTIC FEEDBACK

(71) Applicant: Samsung Electronics Co., Ltd., Gyeonggi-do (KR)

(72) Inventors: Yu-dong BAE, Gyeonggi-do (KR); Jeong-rok Park, Gyeonggi-do (KR); Jin-hyoung Park, Gyeonggi-do (KR); Eun-hwa Lee, Gyeonggi-do (KR); Myung-hwan Lee, Gyeonggi-do (KR)

(73) Assignee: Samsung Electronics Co., Ltd.

(21) Appl. No.: 14/581,093

(22) Filed: Dec. 23, 2014

(30) Foreign Application Priority Data
Dec. 23, 2013 (KR) 10-2013-0161785

(51) Int. Cl. G06F 3/01; G06F 3/0354; G06F 3/041

(52) U.S. Cl. CPC G06F 3/016; G06F 3/041; G06F 3/03545

(57) ABSTRACT

A system for providing haptic feedback is provided. The system includes a portable terminal including a body and a first connector part. A cover device that is detachably connected to the body includes a touch sensor for generating a touch signal, a first haptic actuator that generates vibrations based on a haptic signal output from the body of the portable terminal. The haptic signal corresponds to the generated touch signal. A vibration plate is connected to a side of the first haptic actuator and is configured to transfer the generated vibrations to the cover device.

### PRIORITY

This application claims priority under 35 U.S.C. §119(a) to Korean Patent Application Ser. No. 10-2013-0161785, which was filed in the Korean Intellectual Property Office on Dec. 23, 2013, the entire disclosure of which is incorporated herein by reference.

### BACKGROUND OF THE INVENTION

1. Field of the Invention

The present invention relates generally to a method and system for providing haptic feedback, and more particularly, to a cover device that provides haptic feedback.

2. Description of the Related Art

In general, the term “haptic” indicates a tactile sense that a user feels when the user touches an object (e.g., a touch screen of a portable terminal) using a finger tip or a stylus pen. The tactile sense includes tactile feedback that is sensed by the user when a user's finger tip or a stylus pen contacts a surface of the object and Kinesthetic force feedback that is sensed by the user when movements of a joint and a muscle are obstructed.

Recently-released portable terminals have a function for outputting a voice or vibration in response to a touch input by a user and for providing the user with feedback that corresponds to the touch input.

In particular, for a portable terminal having haptic technology capabilities, there is an ongoing need for a vibration generating device that generates various types of vibrations to provide various tactile feedbacks in response to various user inputs.

### SUMMARY OF THE INVENTION

The present invention has been designed to address at least the problems and/or disadvantages described above and to provide at least the advantages described below.

In accordance with an aspect of the present invention, a system for providing haptic feedback is provided. The system includes a portable terminal including a body and a first connector part. A cover device that is detachably connected to the body includes a touch sensor for generating a touch signal, a first haptic actuator that generates vibrations based on a haptic signal output from the body of the portable terminal, the haptic signal corresponds to the generated touch signal, a vibration plate connected to a side of the first haptic actuator and configured to transfer the generated vibrations to the cover device.

In accordance with another aspect of the present invention, a system for providing haptic feedback is provided. The system includes a portable terminal including a body and a first connector part, a cover device detachably connected to the body, and a stylus pen that is detachably connected to the cover device. The stylus pen includes a second haptic actuator that generates vibrations based on a haptic signal output from the body of the portable terminal. The cover device includes a touch sensor for generating a touch signal which corresponds to the haptic signal and a vibration plate that is connected to a side of the stylus pen and configured to transfer the generated vibrations to the cover device.

In accordance with another aspect of the present invention, a portable terminal is provided. The portable terminal includes a power supply unit that supplies power to a cover device that is detachably connected to a body of the portable terminal, a touch signal receiving unit that receives a touch signal generated from a touch sensor disposed on the cover device, a haptic signal generating unit that generates a haptic signal corresponding to the generated touch signal, a haptic signal output unit that transmits the generated haptic signal to the cover device, and a first connector part configured for inputting and outputting the power, the touch signal, and the haptic signal. The haptic signal is transmitted to a first actuator, which is disposed on the cover device, to generate vibrations.

In accordance with another aspect of the present invention, a cover device is provided. The cover device includes a front cover that includes a touch sensor and a vibration plate, a rear cover that detachably connects to a body of a portable terminal and includes a second connector part that is electrically connected to the body of the portable terminal, and a connecting member that includes a first haptic actuator that is connected to a side of the vibration plate. The second connector part is configured to transmit, to the body of the portable terminal, a touch signal that is generated from the touch sensor and receive a haptic signal output from the body of the portable terminal, and wherein the vibration plate is configured to transfer, to the front cover, vibrations that are generated by the first haptic actuator based on the haptic signal.

In accordance with another aspect of the present invention, a stylus pen is provided. The stylus pen includes a third connector part that detachably and electrically connects to a cover device, a haptic signal receiving unit that receives a haptic signal output from the third connector part, and a second haptic actuator that generates vibrations based on the received haptic signal. The haptic signal is output from a body of a portable terminal and corresponds to a touch signal that is generated in the cover device. The body of the portable terminal is electrically connected to the cover device. The vibrations that are generated by the second haptic actuator are transferred to the cover device via a vibration plate disposed on the cover device.

In accordance with another aspect of the present invention, a method of outputting a haptic signal is provided. The method is performed by a portable terminal and includes supplying power to a cover device that is detachably connected to a body of the portable terminal, receiving a touch signal that is generated from a touch sensor disposed on the cover device, generating a haptic signal that corresponds to the touch signal, and transmitting the haptic signal to the cover device. The haptic signal is transmitted to a first haptic actuator disposed on the cover device to generate vibrations.

In accordance with another aspect of the present invention, a method of providing haptic feedback is provided. The method is performed by a cover device and includes receiving power from a portable terminal, transmitting, to the portable terminal, a touch signal that is generated from a touch sensor disposed on the cover device, receiving a haptic signal output from the portable terminal and corresponding to the touch signal, generating, by a first haptic actuator, vibrations based on the received haptic signal, and providing haptic feedback via a vibration plate that is connected to a side of the first haptic actuator.

In accordance with another aspect of the present invention, a method of outputting a haptic signal is provided. The method is performed by a portable terminal and includes supplying power to a cover device that is detachably connected to a body of the portable terminal, receiving a touch signal that is generated from a touch sensor disposed on the cover device, generating a haptic signal that corresponds to the received touch signal, and transmitting the haptic signal to a stylus pen that is detachably connected to the cover device. The haptic signal is transmitted to a second haptic actuator disposed on the stylus pen to generate vibrations.

In accordance with another aspect of the present invention, a method of providing haptic feedback is provided. The method is performed by a cover device and includes receiving power from a portable terminal, transmitting, to the portable terminal, a touch signal that is generated from a touch sensor disposed on the cover device, and providing the haptic feedback via a vibration plate, which is disposed on the cover device, that is connected with a side of a stylus pen. A haptic signal that is output from the portable terminal and corresponds to the touch signal is transmitted to the stylus pen, and vibrations are generated by a second haptic actuator disposed on the stylus pen based on the output haptic signal.

In accordance with another aspect of the present invention, a method of generating vibrations is provided. The method is performed by a stylus pen and includes receiving power from a portable terminal, receiving a haptic signal from the portable terminal, and generating the vibrations by a second haptic actuator based on the received haptic signal. The haptic signal is output from the portable terminal and corresponds to a touch signal that is generated from a touch sensor disposed on a cover device that is detachably connected to the portable terminal. The vibrations that are generated by the second haptic actuator are transferred to the cover device.

In accordance with another aspect of the present invention, a non-transitory computer-readable recording medium having recorded thereon a program, which, when executed by a computer, performs a method of outputting a haptic signal is provided. The method is performed by a portable terminal and includes supplying power to a cover device that is detachably connected to a body of the portable terminal, receiving a touch signal that is generated from a touch sensor disposed on the cover device, generating a haptic signal that corresponds to the received touch signal, and transmitting the haptic signal to the cover device. The haptic signal is used by a first haptic actuator disposed on the cover device to generate vibrations.

### BRIEF DESCRIPTION OF THE DRAWINGS

The above and other aspects, features, and advantages of certain embodiments of the present invention will be more apparent from the following detailed description when read in conjunction with the accompanying drawings, in which:

FIG. 1 is a diagram illustrating a cover device attached to a body of a portable terminal, according to an embodiment of the present invention;

FIG. 2 is a diagram illustrating the body of the portable terminal, according to an embodiment of the present invention;

FIG. 3 is a block diagram of the portable terminal, according to an embodiment of the present invention;

FIG. 4 is a diagram illustrating a front view of the cover device, according to an embodiment of the present invention;

FIG. 5 is a partial, cross-sectional view of the cover device, according to the embodiment of the present invention;

FIG. 6 is a flowchart illustrating a method of providing haptic feedback by controlling the portable terminal and using the cover device, according to an embodiment of the present invention;

FIG. 7 is a diagram illustrating a status of the cover device from which a stylus pen is detached, according to an embodiment of the present invention;

FIG. 8 is a block diagram of the stylus pen, according to an embodiment of the present invention; and

FIG. 9 is a flowchart illustrating a method of providing haptic feedback by controlling the portable terminal and the stylus pen and using the cover device, according to an embodiment of the present invention.

### DETAILED DESCRIPTION OF EMBODIMENTS OF THE PRESENT INVENTION

One or more embodiments of the present invention will now be described more fully with reference to the accompanying drawings, in which embodiments of the invention are shown. The invention may, however, be embodied in many different forms, and should not be construed as being limited to the embodiments set forth herein. Thus, the invention may include all revisions, equivalents, or substitutions which are included in the concept and the technical scope related to the invention.

While terms “first” and “second” are used to describe various components, it is obvious that the components are not limited to the terms “first” and “second”. The terms “first” and “second” are used only to distinguish between each component.

Furthermore, all examples and conditional language recited herein are to be construed as being without limitation to such specifically recited examples and conditions. Throughout the specification, a singular form may include plural forms, unless there is a particular description contrary thereto. Also, terms such as “comprise” or “comprising” are used to specify existence of a recited form, a number, a process, an operation, a component, and/or groups thereof, not excluding the existence of one or more other recited forms, one or more other numbers, one or more other processes, one or more other operations, one or more other components and/or groups thereof.

Various embodiments of the present invention are described in detail below with reference to the accompanying drawings. The same reference numbers are used throughout the drawings to refer to the same or like parts. Additionally, detailed descriptions of well-known functions and structures incorporated herein may be omitted to avoid obscuring the subject matter of the present invention. As used herein, the term “and/or” includes any and all combinations of one or more of the associated listed items.

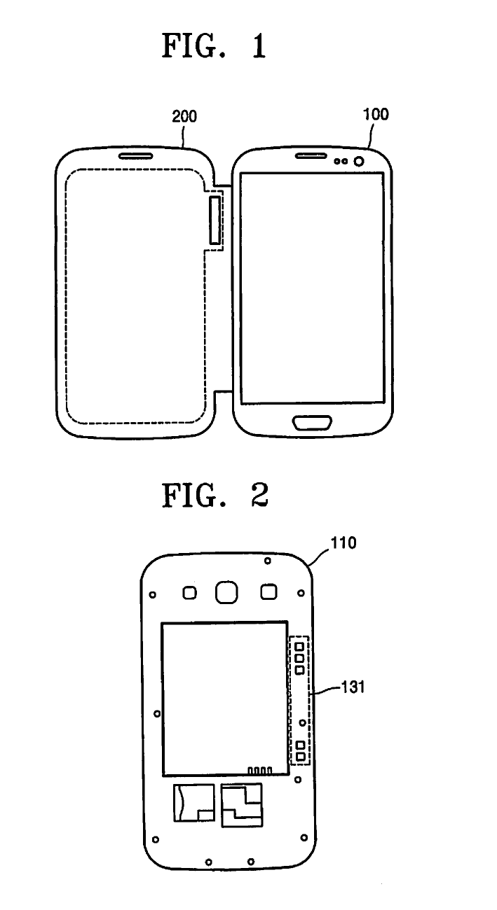

FIG. 1 is a diagram illustrating a cover device 200 attached to a body 110 (FIG. 2) of a portable terminal 100, according to an embodiment of the present invention.

The cover device 200 detachably connects to the body 110 of the portable terminal 100 and may be in the form of a flip cover.

FIG. 2 is a diagram illustrating the body 110 of the portable terminal 100, according to an embodiment of the present invention.

As illustrated in FIG. 2, a first connector part 131 is disposed on the body 110 of the portable terminal 100. For example, as illustrated in FIG. 2, the first connector part 131 is disposed on a rear side of the body 110 and contacts a second connector part 211a that is disposed on an inner side surface of a rear cover 210 of the cover device 200 (see FIG. 4).

When the cover device 200 is disposed on the body 110 of the portable terminal 100, the first connector part 131 electrically connects the body 110 and the cover device 200 to one another. For example, power that is supplied from the portable terminal 100 via the first connector part 131 may be provided to the cover device 200 via the second connector part 211a. Also, due to the contact between the first connector part 131 of the portable terminal 100 and the second connector part 211a of the cover device 200, a touch signal and/or a haptic signal may be transmitted between the portable terminal 100 and the cover device 200, as described below.

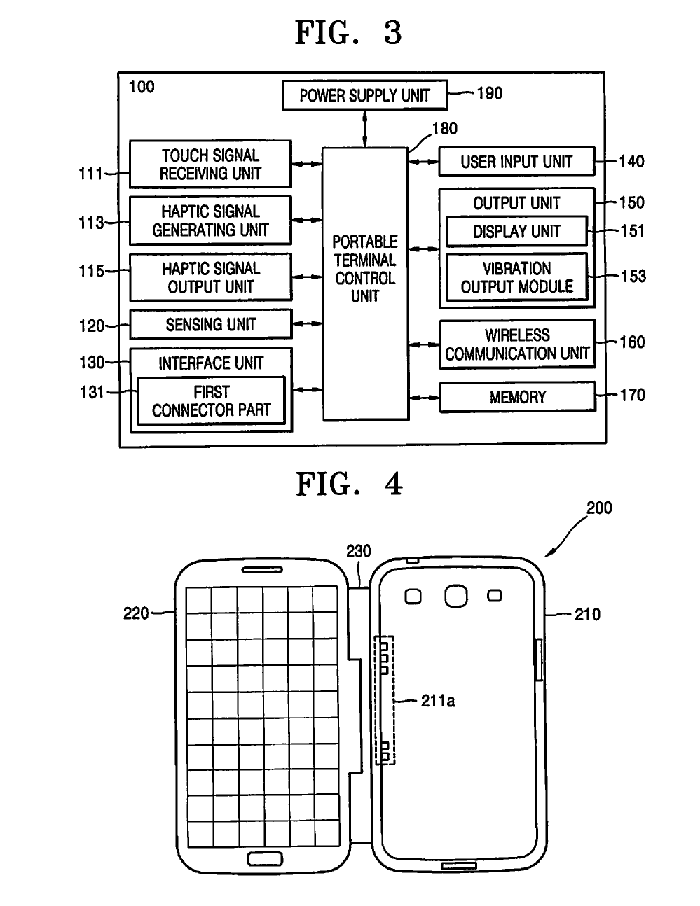

FIG. 3 is a block diagram of the portable terminal 100, according to an embodiment of the present invention.

As illustrated in FIG. 3, the portable terminal 100 includes a touch signal receiving unit 111, a haptic signal generating unit 113, a haptic signal output unit 115, a sensing unit 120, an interface unit 130, the first connector part 131, a user input unit 140, an output unit 150, a display unit 151, vibration output module 153, a wireless communication unit 160, a memory 170, a portable terminal control unit 180, and a power supply unit 190.

The portable terminal 100 may be embodied in various forms electronic devices such as a digital camera, a mobile phone, a smartphone, a laptop computer, a tablet personal computer (PC), an electronic book terminal, a terminal for digital broadcasting, a personal digital assistant (PDA), or a portable multimedia player (PMP) that may provide haptic feedback in response to a touch signal.

All operations by the portable terminal 100 are generally controlled by the portable terminal control unit 180.

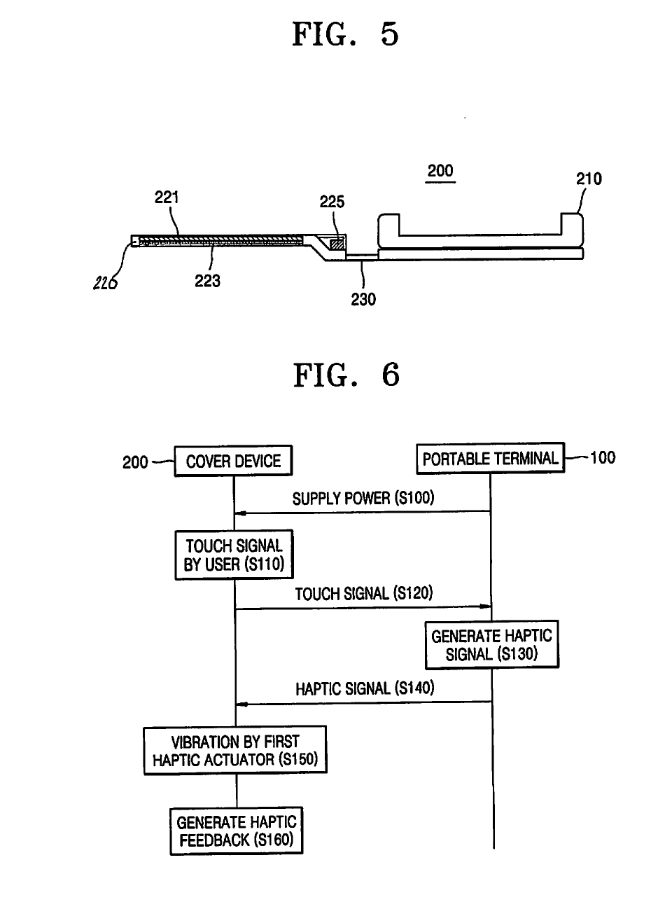

The touch signal receiving unit 111 receives a touch signal that is generated by a touch sensor 221 (FIG. 5) disposed on the cover device 200.

The haptic signal generating unit 113 generates a haptic signal that corresponds to the touch signal received by the touch signal receiving unit 111.

The haptic signal output unit 115 transmits the haptic signal that is generated by the haptic signal generating unit 113 to the cover device 200.

Power, the touch signal, and the haptic signal may be input and/or output between the portable terminal 100 and an external device due to contact between the first connector part 131 of the portable terminal 100 and a connector part of the external device.

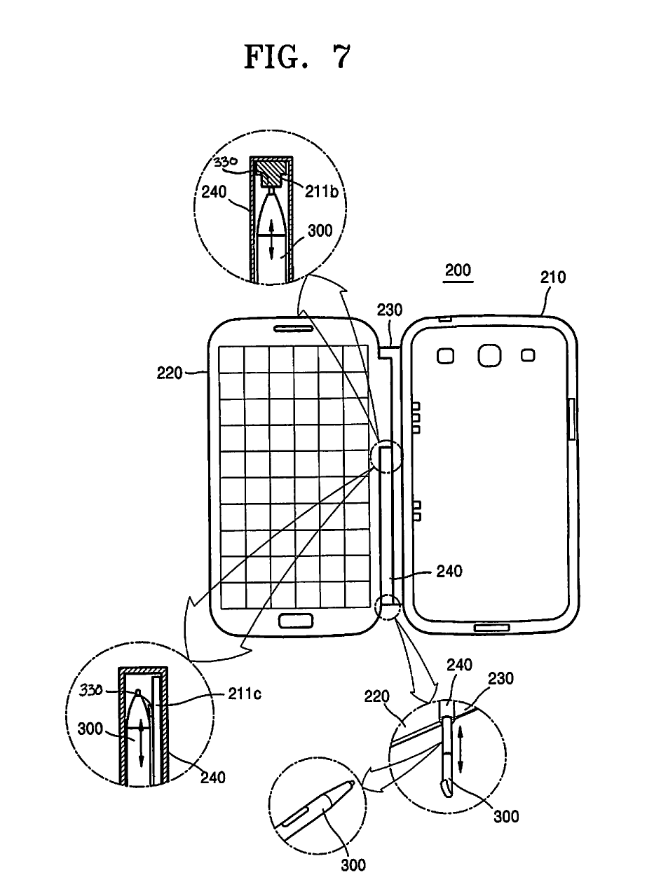

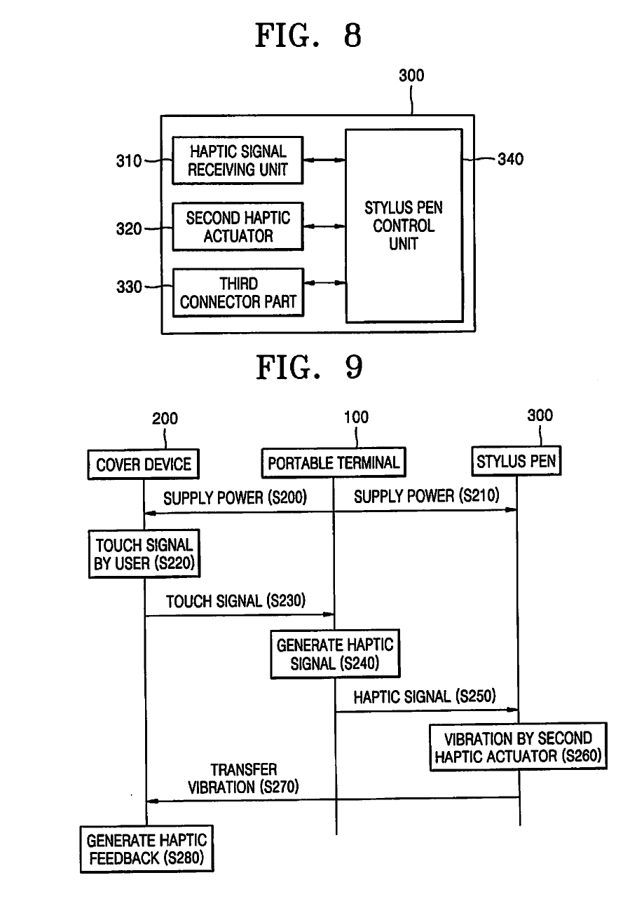

The external device may be the cover device 200 including the second connector part 211a (FIG. 4) or fourth connector parts 211b and 211c (FIG. 7), or may be a stylus pen 300 including a third connector part 330 (FIGS. 7 and 8).

The sensing unit 120 senses a current status of the portable terminal 100, e.g., an open or closed status of the portable terminal 100, a location of the portable terminal 100, a user's contact or non-contact, bearings (or coordinates) of the portable terminal 100, or acceleration/deceleration of the portable terminal 100, and generates a sensing signal for controlling an operation of the portable terminal 100 based on the sensed current status.

The sensing unit 120 may have various sensors arranged in or near a touch screen of the portable terminal 100 thereby allowing the sensing unit 120 to sense a touch on or proximate to the touch screen.

Also, the sensing unit 120 senses an opening and closing of the cover device 200 according to a change in illuminance by using an illuminance sensor of the portable terminal 100.

The sensing unit 120 senses rotation of the portable terminal 100 by using a motion sensor of the portable terminal 100.

For example, when the portable terminal 100 senses an opening of the cover device 200 by using the illuminance sensor and the rotation of the portable terminal 100 by using the motion sensor, a touch pad attached to the cover device 200 may be activated.

Also, the sensing unit 120 performs a sensing function in relation to a power supply of the portable terminal 100 by the power supply unit 190 and detects a defect of an external device by the interface unit 130.

The interface unit 130 functions as an interface with all external devices that may be connected to the portable terminal 100. For example, the external devices may connect to the portable terminal 100 using a wireless/wired headset port, an external charger port, a wireless/wired data port, a memory card port, a port for connection with a device having an identifier module, an audio input/output (I/O) port, a video I/O port, or an earphone port.

The interface unit 130 includes the first connector part 131 that functions as an interface with the cover device 200 when the cover device 200 is attached to the body 110 of the portable terminal 100.

As noted above, the first connector part 131 is disposed on the rear side of the body 110 and may function as a connection path for power supplied to the cover device 200, a touch signal received from the cover device 200, and a haptic signal output to the cover device 200.

The user input unit 140 may include a key that generates an electrical signal when touched by a user of the portable terminal 100. The electrical signal that is generated by the user input unit 140 is transmitted to the portable terminal control unit 180 thereby allowing the portable terminal control unit 180 to control the portable terminal 100.

The user input unit 140 generates input data for controlling operations of the portable terminal 100. For example, the user input unit 140 may include a key pad, a dome switch, a touch pad (a touch capacitive-type touch pad, a pressure resistive-type touch pad, an infrared beam sensing-type touch pad, a surface acoustic wave-type touch pad, an integral strain gauge-type touch pad, a Piezoelectric effect-type touch pad, or the like), a jog wheel, or a jog switch. In accordance with one particular embodiment, a touch pad and the display unit 151, which are described in more detail below, may form a mutually-layered structure and may be configured as a touch screen.

The user input unit 140 senses a user's touch gesture on the touch screen and transmits information about the touch gesture to the portable terminal control unit 180 by using a touch screen module stored in the memory 170. The touch screen module may be configured as a separate controller (e.g., as separate hardware).

The output unit 150 outputs an audio signal, a video signal, and/or an alarm signal. The output unit 150 includes the display unit 151 and the vibration output module 153.

The display unit 151 displays and outputs information that is processed in the portable terminal 100. For example, when the portable terminal 100 is in a call mode, the display unit 151 displays a user interface (UI) or graphical user interface (GUI), which is related to a call. When the call mode indicates a video call mode or an image-capturing mode, the display unit 151 displays a captured and/or received image or an UI or a GUI.

The vibration output module 153 outputs vibration signals to notify a user of an event that occurs in the portable terminal 100. Examples of an event that can occur in the portable terminal 100 may include a call signal reception, a message reception, or a key signal input. Also, the vibration output module 153 outputs a vibration in response to a user's touch input, thereby providing vibrational feedback that corresponds to the user's touch input.

The wireless communication unit 160 may include one or more elements for wireless communication between the portable terminal 100 and a wireless communication system and/or for wireless communication between the portable terminal 100 and a network where the portable terminal 100 is positioned. The wireless communication unit 160 may, for example, include a short-distance communication module.

The short-distance communication module is arranged for short-distance communication. Examples of the short-distance communication systems may include, but is not limited to, Bluetooth™, radio frequency identification (RFID), infrared data association (IrDA), ultra wideband (UWB), ZigBee™, and near field communication (NFC).

The memory 170 may include at least one storage medium including a flash memory-type storage medium, a hard disk-type storage medium, a multimedia card micro-type storage medium, card-type memories (e.g., an SD card, an XD memory, and the like), random access memory (RAM), static random access memory (SRAM), read-only memory (ROM), electrically erasable programmable read-only memory (EEPROM), programmable read-only memory (PROM) magnetic memory, a magnetic disc, and an optical disc.

The programs stored in the memory 170 may be classified into a plurality of modules according to their functions, for example, into a UI module, a touch screen module, or the like.

The UI module may provide a UI, a GUI, or the like that are configured to interoperate with the portable terminal 100. Functions of the UI module are known by those of ordinary skill in the art, thus, detailed descriptions thereof are omitted.

The touch screen module may detect a user's touch gesture on the touch screen and may transmit information about the touch gesture to the portable terminal control unit 180. The touch screen module may be configured as a separate controller (e.g., as separate hardware).

The power supply unit 190 supplies power to the cover device 200.

The power supply unit 190 also supplies power to the stylus pen 300.

For example, power may be provided as a result of contact between the first connector part 131 of the portable terminal 100 and the second connector part 211a of the cover device 200. Also, a pen holder 240 (FIG. 7), from which the stylus pen 300 may be detached, may be disposed on the cover device 200, and fourth connector parts 211b and 211c that are connected with the first connector part 131 of the portable terminal 100 may be disposed on (or within) the pen holder 240. In this case, as a result of contact between the third connector part 330 disposed on a side of the stylus pen 300 and the fourth connector parts 211b and 211c of the pen holder 240, power may be supplied from the portable terminal 100 to the stylus pen 300.

FIG. 4 is a diagram illustrating a front view of the cover device 200, according to an embodiment of the present invention, and FIG. 5 is a partial cross-sectional view of the cover device 200 according to the embodiment of the present invention.

The cover device 200 includes a front cover 220, the rear cover 210, and a connecting member 230.

The front cover 220 includes the touch sensor 221 and a vibration plate 223 arranged therein (FIG. 5). For example, the vibration plate 223 may be connected with a side of a first haptic actuator 225 or a second haptic actuator 320 (FIG. 8) that generates a vibration in response to a haptic signal, thereby transferring haptic feedback via the front cover 220 to a user.

The rear cover 210 includes the second connector part 211a.

The second connector part 211a contacts the first connector part 131, which is disposed on the rear side of the body 110 of the portable terminal 100 to electrically connect the cover device 200 to the portable terminal 100.

For example, the second connector part 211a may function as a connection path thereby allowing a touch signal that is generated by the touch sensor 221 to be transmitted to the body 110 and a haptic signal to be output from the body 110.

The connecting member 230 includes the pen holder 240 and/or the first haptic actuator 225 from which the stylus pen 300 may be detached.

The second haptic actuator 320 may be disposed on the stylus pen 300.

The front cover 220 of the cover device 200 includes the touch sensor 221 and the vibration plate 223 arranged therein (FIGS. 4 and 5).

The touch sensor 221 detects a touch input when pressed by a user and inputs an instruction, which may be displayed on a screen of the portable terminal 100. The touch sensor 221 may include a touch pad.

A suitable type of touch pad may include, for example, a touch capacitive-type touch pad, a pressure resistive-type touch pad, an infrared beam sensing-type touch pad, a surface acoustic wave-type touch pad, an integral strain gauge-type touch pad, a Piezoelectric effect-type touch pad, or the like.

The touch pad and a display may form a mutually-layered structure and thus may be configured as a touch screen. For example, the display may be an electronic ink (E-ink) display. Accordingly, the cover device 200 consumes relatively little power and the overall size of the cover device 200 is relatively thin.

When the display and the touch pad form the mutually-layered structure and are formed as a touch screen, the display may be used as both an output device and input device. The touch screen may be configured to sense a position of a touch input and a touched area of the touch input, and the touch screen may also be configured to sense pressure of the touch input. Also, the touch screen may be configured to sense an actual touch in addition to sensing a touch proximate to the touch screen.

The user input unit 140 senses a user's touch gesture on the touch screen and transmits information about the touch gesture to the portable terminal control unit 180. The touch screen module may be configured as a separate controller (e.g., as separate hardware).

Although not illustrated, in order to sense a touch on or proximate to the touch screen, various sensors may be arranged in or near the touch screen.

An example of a sensor configured to sense the touch on the touch screen may include a tactile sensor. The tactile sensor may be configured to sense contact of a specific object by at least as much as a person can sense the same contact of the specific object. The tactile sensor may sense various types of information such as the roughness of contact surface, the hardness of the contact object, the temperature of contact point, or the like.

An example of a sensor that may be used to sense a touch on the touch screen may include a proximity sensor.

The proximity sensor may be configured to sense the existence of an object that approaches a predetermined detection surface or that exists nearby by using a force of an electro-magnetic field or an infrared ray. Thus, compared to a contact-type sensor, the proximity sensor has a significantly long lifetime and may be variously used.

Examples of a proximity sensor include a transmission-type photoelectric sensor, a direction reflection-type photoelectric sensor, a mirror reflection-type photoelectric sensor, a high frequency oscillation-type proximity sensor, a capacity-type proximity sensor, a magnetic proximity sensor, an infrared-type proximity sensor, or the like.

For example, when the portable terminal 100 senses an opening of the cover device 200 by using the illuminance sensor of the portable terminal 100 and the rotation of the portable terminal 100 by using the motion sensor of the portable terminal 100, a touch screen arranged at the cover device 200 may be activated.

The touch gesture (i.e., an input) of the user may include a tap gesture, a touch & hold gesture, a double tap gesture, a drag gesture, a panning gesture, a flick gesture, a drag & drop gesture, a swipe gesture, or the like.

In this case, when the touch sensor 221, which may be disposed on the front cover 220 of the cover device 200, is touched, a touch signal is generated according to a touched area, so that a screen may be changed in a display of the front cover 220 or a display of the body 110, or a sound and haptic feedback may occur, as will be described in detail below with reference to FIGS. 6 through 9.

The vibration plate 223 may be arranged below the touch sensor 221, and vibration of the first haptic actuator 225 disposed on the connecting member 230 may be transferred to an entire area of the front cover 220.

The vibration plate 223 may be formed of one or more suitable types of metal and/or metal alloys, e.g., a steel use stainless (SUS). Alternatively, the vibration plate 223 may be formed of plastic and molded to form the front cover 220, via a molding process.

Also, the vibration plate 223 may be flat or may have at least one projecting area or projection, e.g., a protrusion, nub, or the like; this may depend on a manufacturer's contemplated uses. In the latter instance, for example, when the portable terminal 100 is attached to the cover device 200 including at least one projecting area (or at least one projection) and is used on a desk or a pad, it is possible to prevent(or decrease) vibrations that may be transferred from the first haptic actuator 225 to the vibration plate 223; that is, the vibrations are prevented (or decreased) due to damping between the cover device 200 and the desk or the pad, as a result of the at least one projection absorbing some of the vibrations.

The first haptic actuator 225 may be structurally connected with the vibration plate 223 of the front cover 220 may include vibration motor, a solenoid actuator, or a piezo actuator.

The vibration plate 223 of the cover device 200 may be disposed not only on the front cover 220 but may also extend to a portion of the connecting member 230, and the first haptic actuator 225 that is structurally connected with the vibration plate 223 may be disposed on a portion of the connecting member 230. Accordingly, the front cover 220 may be relatively thin, and a vibration that is generated by the first haptic actuator 225 may be transferred to the vibration plate 223 to provide haptic feedback to a user the portable terminal 100.

FIG. 6 is a flowchart illustrating a method of providing haptic feedback, 1 by controlling the portable terminal 100 and using the cover device 200, according to an embodiment of the present invention.

At step S100, the cover device 200 receives power from the portable terminal 100.

For example, due to contact between the first connector part 131 of the portable terminal 100 and the second connector part 211a of the cover device 200, power may be supplied from the portable terminal 100 to the cover device 200.

At step S110, the cover device 200 generates a touch signal in response to a touch input sensed by the touch sensor 221 disposed on the cover device 200.

For example, when the touch sensor 221 receives the touch input by a user, the touch signal including a position of the touch input, a touched area of the touch input, and a pressure of the touch input is generated.

At step S120, the cover device 200 transmits the touch signal generated at step 110 to the portable terminal 100.

For example, due to the contact between the first connector part 131 of the portable terminal 100 and the second connector part 211a of the cover device 200, the touch signal is transmitted from the cover device 200 to the portable terminal 100.

At step S130, the portable terminal 100 generates a haptic signal based on the touch signal received at step 120.

For example, the portable terminal 100 senses a touch gesture based on the touch signal, obtains information about the touch gesture, and generates the haptic signal.

The haptic signal may be used to allow the first haptic actuator 225 disposed on the cover device 200 to generate vibration.

At step S140, the cover device 200 receives the haptic signal from the portable terminal 100.

For example, due to the contact between the first connector part 131 of the portable terminal 100 and the second connector part 211a of the cover device 200, the haptic signal is transmitted from the portable terminal 100 to the cover device 200.

At step S150, the vibration is generated by the first haptic actuator 225 of the cover device 200 based on the haptic signal received from the portable terminal 100 at step 140.

At step S160, based on the vibration generated by the first haptic actuator 225 at step 150, the cover device 200 provides haptic feedback to the front cover 220 of the cover device 200 via the vibration plate 223 connected on the side of the first haptic actuator 225.

FIG. 7 is a diagram illustrating a status of the cover device 200 from which the stylus pen 300 is detached, according to an embodiment of the present invention.

As illustrated in FIG. 7, the pen holder 240 from which the stylus pen 300 may be detached is disposed on the connecting member 230 of the cover device 200.

The stylus pen 300 functions to input data to the touch screen of the portable terminal 100 or the cover device 200, to input data according to an application mode, and/or to perform a search operation; the stylus pen has a relatively sharp tip for easy data input. The stylus pen 300 may be an electromagnetic resonance (EMR) pen or an electronic pen.

As illustrated in FIG. 7, the third connector part 330 may be arranged at an end of the stylus pen 300. Alternatively, the third connector part 330 may be arranged at a side of the stylus pen 300.

The cover device 200 may be attached to the body 110 of the portable terminal 100, and the stylus pen 300 may be inserted into the pen holder 240 of the cover device 200. In this case, the third connector part 330 may contact the fourth connector parts 211b and 211c disposed in the pen holder 240 of the cover device 200. Also, the fourth connector parts 211b and 211c may be electrically connected with the second connector part 211a disposed on the inner side surface of the rear cover 210 of the cover device 200.

Accordingly, due to the contact between the first connector part 131 of the portable terminal 100 and the second connector part 211a of the cover device 200, or the contact between the fourth connector parts 211b and 211c of the cover device 200 and the third connector part 330 of the stylus pen 300, power, a touch signal, or a haptic signal may be transferred between the portable terminal 100, the cover device 200, and the stylus pen 300.

FIG. 8 is a block diagram of the stylus pen 300, according to an embodiment of the present invention.

As illustrated in FIG. 8, the stylus pen 300 may include a haptic signal receiving unit 310, a second haptic actuator 320, the third connector part 330, and a stylus pen control unit 340.

The third connector part 330 electrically connects to the cover device 200 and the stylus pen 300.

The haptic signal receiving unit 310 receives a haptic signal that is output from the third connector part 330.

The haptic signal may be a signal that is output from the body 110 of the portable terminal 100, which is electrically connected with the cover device 200, and corresponds to a touch signal generated by the cover device 200.

The second haptic actuator 320 generates a vibration based on the haptic signal that is received from the haptic signal receiving unit 310.

The second haptic actuator 320 is used to provide haptic feedback to the cover device 200. The second haptic actuator 320 may include vibration motor, a solenoid actuator, or a piezo actuator.

The vibration that is generated by the second haptic actuator 320 may be transferred to the cover device 200 via the vibration plate 223 of the cover device 200.

The stylus pen control unit 340 controls all operations of the stylus pen 300 by controlling the haptic signal receiving unit 310, the second haptic actuator 320, and the third connector part 330.

FIG. 9 is a flowchart illustrating a method of providing haptic feedback by controlling the portable terminal 100 and the stylus pen 300 and using the cover device 200, according to an embodiment of the present invention.

At step S200, the cover device 200 receives power from the portable terminal 100.

For example, due to contact between the first connector part 131 of the portable terminal 100 and the second connector part 211a of the cover device 200, power may be supplied from the portable terminal 100 to the cover device 200.

At step S210, the stylus pen 300 receives power from the portable terminal 100.

For example, the power may be supplied from the portable terminal 100 to the cover device 200 due to the contact between the first connector part 131 of the portable terminal 100 and the second connector part 211a 0 of the cover device 200. The power that is supplied to the cover device 200 may be supplied to the stylus pen 300 due to contact between the fourth connector parts 211b and 211c disposed in the pen holder 240 and the third connector part 330 of the stylus pen 300.

At step S220, the cover device 200 generates a touch signal in response to a user's touch input to the touch sensor 221 of the cover device 200.

For example, when the user's touch input to the touch sensor 221 of the cover device 200 is performed, the touch signal, including a position of the user's touch input, a touched area of the user's touch input, and a pressure of the user's touch input is generated.

At step S230, the cover device 200 transmits the touch signal generated at step S220 to the portable terminal 100.

For example, due to the contact between the first connector part 131 of the portable terminal 100 and the second connector part 211a of the cover device 200, the touch signal is transmitted from the cover device 200 to the portable terminal 100.

At step S240, the portable terminal 100 generates a haptic signal based on the touch signal received in operation S220.

For example, the portable terminal 100 senses a touch gesture based on the touch signal, obtains information about the touch gesture, and generates the haptic signal.

The haptic signal is used to allow the second haptic actuator 320 arranged at the stylus pen 300 to generate vibration.

At step S250, the stylus pen 300 receives the haptic signal from the portable terminal 100.

For example, due to contact between the first connector part 131 of the portable terminal 100 and the second connector part 211a of the cover device 200, the haptic signal is transmitted from the portable terminal 100 to the cover device 200. Also, the haptic signal that is transmitted to the cover device 200 is received by the stylus pen 300 due to the contact between the fourth connector parts 211b and 211c disposed in the pen holder 240 and the third connector part 330 of the stylus pen 300.

At step S260, the second haptic actuator 320 of the stylus pen 300 generates vibration based on the haptic signal that is received from the portable terminal 100 at step S250.

At step operation S270, the stylus pen 300 transfers the vibration, which is generated at step S260 by the second haptic actuator 320, to the vibration plate 223 that is connected to a side of the stylus pen 300.

At step S280, the cover device 200 provides haptic feedback to the front cover 220 by using the vibration transferred at step S270 from the stylus pen 300.

In addition, embodiments in accordance with the present invention can also be implemented through computer readable code/instructions in/on a medium, e.g., a computer readable medium, to control at least one processing element to implement any of the embodiments of the present invention herein described. The medium can correspond to any medium/media permitting the storage and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as Internet transmission media.

In accordance with the embodiments of the present invention, a non-transitory computer-readable recording medium having recorded thereon a program, which, when executed by a computer, performs a method of outputting a haptic signal, is provided. The method is performed by a portable terminal and includes supplying power to a cover device that is detachably connected to a body of the portable terminal, receiving a touch signal that is generated from a touch sensor disposed on the cover device, generating a haptic signal that corresponds to the received touch signal, and transmitting the haptic signal to the cover device, wherein the haptic signal is used by a first haptic actuator disposed on the cover device to generate vibrations.

It should be understood that the embodiments described herein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims and their equivalents.

What is claimed is:

1. A system for providing haptic feedback, the system comprising:
a portable terminal comprising a body and a first connector part; and
a cover device detachably connected to the body comprising:
a touch sensor for generating a touch signal;
a first haptic actuator that generates vibrations based on a haptic signal output from the body of the portable terminal, the haptic signal corresponding to the generated touch signal; and
a vibration plate connected to a side of the first haptic actuator and configured to transfer the generated vibrations to the cover device.

2. The system of claim 1, wherein the cover device further comprises:
a front cover that comprises the touch sensor and the vibration plate;
a rear cover that comprises a second connector part that contacts the first connector part of the portable terminal; and
a connecting member that comprises a first haptic actuator that is connected to a side of the vibration plate.

3. The system of claim 1, wherein the touch sensor comprises a touch screen.

4. The system of claim 1, wherein the touch sensor is activated according to a change in illuminance which is sensed by the body of the portable terminal.

5. The system of claim 1, wherein a side of the vibration plate includes at least one projection that is configured to absorb some of the generated vibrations.

6. A system for providing haptic feedback, the system comprising:
a portable terminal comprising a body and a first connector part;
a cover device detachably connected to the body; and
a stylus pen that is detachably connected to the cover device,
wherein the stylus pen comprises a second haptic actuator that generates vibrations based on a haptic signal output from the body of the portable terminal, and
wherein the cover device comprises:
a touch sensor for generating a touch signal which corresponds to the haptic signal; and
a vibration plate that is connected to a side of the stylus pen and configured to transfer the generated vibrations to the cover device.

7. The system of claim 6, wherein the cover device further comprises a fourth connector part configured to sense when the stylus pen is detached from the cover device, and
wherein the stylus pen comprises a third connector part that contacts the fourth connector part of the cover device.

8. A portable terminal comprising:
a power supply unit that supplies power to a cover device that is detachably connected to a body of the portable terminal;
a touch signal receiving unit that receives a touch signal generated from a touch sensor disposed on the cover device;
a haptic signal generating unit that generates a haptic signal corresponding to the generated touch signal;
a haptic signal output unit that transmits the generated haptic signal to the cover device; and
a first connector part configured for inputting and outputting the power, the touch signal, and the haptic signal,
wherein the haptic signal is transmitted to a first actuator, which is disposed on the cover device, to generate vibrations.

9. A cover device comprising:
a front cover that comprises a touch sensor and a vibration plate;
a rear cover that detachably connects to a body of a portable terminal and comprises a second connector part that is electrically connected to the body of the portable terminal; and
a connecting member that comprises a first haptic actuator that is connected to a side of the vibration plate,
wherein the second connector part is configured to transmit, to the body of the portable terminal, a touch signal that is generated from the touch sensor and receive a haptic signal output from the body of the portable terminal, and
wherein the vibration plate is configured to transfer, to the front cover, vibrations that are generated by the first haptic actuator based on the haptic signal.

10. The cover device of claim 9, wherein the touch sensor comprises a touch screen.

11. The cover device of claim 9, wherein the touch sensor is activated according to a change in illuminance which is sensed by the body of the portable terminal.

12. The cover device of claim 9, wherein a side of the vibration plate includes at least one projection that is configured to absorb some of the generated vibrations.

13. A stylus pen comprising:
a third connector part that detachably and electrically connects to a cover device;
a haptic signal receiving unit that receives a haptic signal output from the third connector part; and
a second haptic actuator that generates vibrations based on the received haptic signal,
wherein the haptic signal is output from a body of a portable terminal and corresponds to a touch signal that is generated in the cover device,
wherein the body of the portable terminal is electrically connected to the cover device, and
wherein the vibrations that are generated by the second haptic actuator are transferred to the cover device via a vibration plate disposed on the cover device.

14. The stylus pen of claim 13, wherein the cover device comprises a fourth connector part that is configured to sense when the stylus pen is detached from the cover device, and
wherein the third connector part of the stylus pen contacts to the fourth connector part of the cover device.

15. A method of outputting a haptic signal, in a portable terminal, comprising:
supplying power to a cover device that is detachably connected to a body of the portable terminal;
receiving a touch signal that is generated from a touch sensor disposed on the cover device;
generating a haptic signal that corresponds to the touch signal; and
transmitting the haptic signal to the cover device,
wherein the haptic signal is transmitted to a first haptic actuator disposed on the cover device to generate vibrations.

16. A method of providing haptic feedback, in a cover device, comprising:
receiving power from a portable terminal;
transmitting, to the portable terminal, a touch signal that is generated from a touch sensor disposed on the cover device;
receiving a haptic signal output from the portable terminal and corresponding to the touch signal;
generating, by a first haptic actuator, vibrations based on the received haptic signal; and
providing haptic feedback via a vibration plate that is connected to a side of the first haptic actuator.

17. A method of outputting a haptic signal, in a portable terminal, comprising:
supplying power to a cover device that is detachably connected to a body of the portable terminal;
receiving a touch signal that is generated from a touch sensor disposed on the cover device;
generating a haptic signal that corresponds to the received touch signal; and
transmitting the haptic signal to a stylus pen that is detachably connected to the cover device,
wherein the haptic signal is transmitted to a second haptic actuator disposed on the stylus pen to generate vibrations.

18. A method of providing haptic feedback, in a cover device comprising:
receiving power from a portable terminal;
transmitting, to the portable terminal, a touch signal that is generated from a touch sensor disposed on the cover device; and
providing the haptic feedback via a vibration plate, which is disposed on the cover device, that is connected with a side of a stylus pen,
wherein a haptic signal that is output from the portable terminal and corresponds to the touch signal is transmitted to the stylus pen, and vibrations are generated by a second haptic actuator disposed on the stylus pen based on the output haptic signal.

19. A method of generating vibrations, a stylus pen, and comprising:
receiving power from a portable terminal;
receiving a haptic signal from the portable terminal; and
generating the vibrations by a second haptic actuator based on the received haptic signal, wherein the haptic signal is output from the portable terminal and corresponds to a touch signal that is generated from a touch sensor disposed on a cover device that is detachably connected to the portable terminal, and
wherein the vibrations that are generated by the second haptic actuator are transferred to the cover device.

20. A non-transitory computer-readable recording medium having recorded thereon a program, which, when executed by a computer, performs a method of outputting a haptic signal, the method performed by a portable terminal and comprising:
supplying power to a cover device that is detachably connected to a body of the portable terminal;
receiving a touch signal that is generated from a touch sensor disposed on the cover device;
generating a haptic signal that corresponds to the received touch signal; and
transmitting the haptic signal to the cover device,
wherein the haptic signal is used by a first haptic actuator disposed on the cover device to generate vibrations.
